(19) United States
(12) Patent Application Publication
(10) Pub. No.: US 2009/0052085 A1
(43) Pub. Date: Feb. 26, 2009

(54) STORAGE APPARATUS AND HEAD SUSPENSION ASSEMBLY

(75) Inventor: Shinji Koganezawa, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/260,675

(22) Filed: Oct. 29, 2008

Related U.S. Application Data
(63) Continuation of application No. PCT/JP2006/309661, filed on May 15, 2006.

(51) Int. Cl. G11B 5/60

(52) U.S. Cl. 360/234.3

(57) ABSTRACT

A head slider has a medium-opposed surface opposed to a storage medium at a distance in a storage apparatus. The medium-opposed surface receives airflow through relative movement between the storage medium and the head slider. The flexure holds the head slider at a predetermined mounting area. The head slider flies above the storage medium in a pitched attitude. A predetermined pitch angle is established in the pitched attitude. An actuator serves to deform the flexure outside the mounting area for the head slider so as to forcefully change the pitched attitude within a predetermined range of a pitch angle. A change in the pitched attitude, namely a change in the pitch angle results in a change in the flying height of the head slider. The flying height can be changed without changing the design of the head slider.

This application is a Continuation of International Application No. PCT/JP2006/309661, filed May 15, 2006.

### BACKGROUND OF THE INVENTION

1. Field of the Invention

The present invention relates to a head suspension assembly incorporated in a storage apparatus such as a hard disk drive, HDD, for example.

2. Description of the Prior Art

A head suspension assembly includes a flying head slider as disclosed in Japanese Patent Application Publication No. 2002-343049, for example. The flying head slider receives airflow generated along a rotating magnetic recording disk. The airflow generates a positive pressure or a lift on the medium-opposed surface of the flying head slider. The flying head slider is thus allowed to fly above the magnetic recording disk at a predetermined flying height.

A piezoelectric element is attached to the outflow end surface of the flying head slider so as to control the flying height. The piezoelectric element is allowed to shrink/expand. The shrinkage/expansion of the piezoelectric element results in a variation in the negative pressure of the flying head slider. This variation enables a change in the flying height of the flying head slider.

A reduction in the size of a flying head slider is a recent trend. It is troublesome to attach a piezoelectric element to such a small-sized flying head slider. In addition, a high accuracy is required for processing. The aforementioned head suspension assembly requires a design change of a conventional flying head slider. An increase in a cost is inevitable for the production of the flying head slider.

### SUMMARY OF THE INVENTION

It is accordingly an object of the present invention to provide a storage apparatus enables a control of a flying height at a low cost. It is also an object of the present invention to provide a head suspension assembly greatly contributing to realization of such a storage apparatus.

According to the present invention, there is provided a storage apparatus comprising: a head slider having a medium-opposed surface opposed to a storage medium at a distance, the head slider designed to move relative to the storage medium; a suspension exhibiting an urging force directed toward the storage medium; a flexure fixed to the suspension, the flexure holding the head slider at a predetermined mounting area; and an actuator causing deformation of the flexure outside the predetermined mounting area so as to change the flying attitude of the head slider within a predetermined range of a pitch angle.

The storage apparatus allows the medium-opposed surface to receive airflow through relative movement between the storage medium and the head slider. The head slider flies above the storage medium in a pitched attitude. A predetermined pitch angle is established in the pitched attitude. The actuator serves to deform the flexure outside the mounting area for the head slider so as to forcefully change the pitched attitude within a predetermined range of a pitch angle. A change in the pitched attitude, namely a change in the pitch angle results in a change in the flying height of the head slider. The flying height can be changed without changing the design of the head slider. A conventional head slider can be employed as the aforementioned head slider. The flying height can be controlled at a low cost.

The storage apparatus may further comprise a piezoelectric element fixed to the surface of the flexure at a position outside the mounting area, the piezoelectric element establishing the actuator. The piezoelectric element establishes the actuator. The piezoelectric element is fixed to the surface of the flexure at a position outside the mounting area for the head slider. The flexure accepts a change in the attitude of the head slider. The piezoelectric element deforms in response to application of a driving voltage, for example. When the piezoelectric element deforms, the flexure correspondingly deforms. Such deformation of the flexure results in a change in the pitched attitude of the head slider. The piezoelectric element may include a thin film made of piezoelectric ceramic. Likewise, the actuator may be a so-called unimorph type piezoelectric actuator.

The storage apparatus may further comprise a piezoelectric element fixed to the back surface of the head slider, the head slider having the front surface, opposite to the back surface, including the medium-opposed surface. The piezoelectric element deforms in response to application of a driving voltage, for example. Since the piezoelectric element is fixed to the back surface of the head slider, deformation of the piezoelectric element results in deformation of the medium-opposed surface of the head slider. In general, the medium-opposed surface of the head slider forms a curved surface. When the piezoelectric element deforms, the curvature of the curved surface correspondingly changes. Such a change in the curvature results in a change in the flying height of the head slider. The head slider is thus allowed to enjoy an enhanced change in the flying height.

A specific head suspension assembly is provided to realize the storage apparatus. The specific head suspension assembly may comprise a head slider having a medium-opposed surface opposed to a storage medium at a distance, the head slider designed to move relative to the storage medium; a suspension exhibiting an urging force directed toward the storage medium; a flexure fixed to the suspension, the flexure holding the head slider at a predetermined mounting area; and an actuator causing deformation of the flexure outside the predetermined mounting area so as to change the flying attitude of the head slider within a predetermined range of a pitch angle.

The head suspension assembly may be incorporated in a storage apparatus, for example. The actuator serves to deform the flexure outside the mounting area for the head slider so as to forcefully change the pitched attitude within a predetermined range of a pitch angle. The actuator is in this manner allowed to change the flying height of the head slider. The flying height can be changed without changing the design of the head slider. A conventional head slider can be employed as the aforementioned head slider. The flying height can be controlled at a low cost.

The head suspension assembly may further comprise: a piezoelectric element fixed to the surface of the flexure at a position outside the mounting area, the piezoelectric element establishing the actuator. The piezoelectric element may include a thin film made of piezoelectric ceramic in the same manner as described above. The actuator may be a so-called unimorph type piezoelectric actuator. Likewise, the head suspension assembly may further comprise a piezoelectric element fixed to the back surface of the head slider, the head slider having the front surface, opposite to the back surface, including the medium-opposed surface.

Another specific head suspension assembly may be provided to realize the storage apparatus. This specific head suspension may comprise: a head slider; a suspension; a flexure fixed to the suspension, the flexure receiving the head slider at a predetermined mounting area, the flexure enabling a change in the attitude of the head slider; and a piezoelectric element fixed to the surface of the flexure at a position outside the predetermined mounting area.

The head suspension assembly may be incorporated in a storage apparatus, for example. The piezoelectric element is fixed to the surface of the flexure at a position outside the mounting area for the head slider. The flexure accepts a change in the attitude of the head slider. The piezoelectric element deforms in response to application of a driving voltage, for example. When the piezoelectric element deforms, the flexure correspondingly deforms. Deformation of the flexure results in a change in the pitched attitude of the head slider. The flying height of the head slider is forced to change. The flying height can be changed without changing the design of the head slider. A conventional head slider can be employed as the aforementioned head slider. The flying height can be controlled at a low cost.

The head suspension assembly may further comprise a piezoelectric element fixed to the back surface of the head slider, the head slider having the front surface including a medium-opposed surface in the same manner as descried above.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive as a specific example of a storage apparatus according to the present invention;

FIG. 2 is a perspective view schematically illustrating a head suspension assembly according to the present invention;

FIG. 3 is an enlarged partial side view schematically illustrating the head suspension assembly;

FIG. 4 is an enlarged partial perspective view schematically illustrating a head suspension assembly according to a first embodiment of the present invention;

FIG. 5 is an enlarged perspective view schematically illustrating an example of a flying head slider;

FIG. 6 is an enlarged partial side view schematically illustrating the flying head slider taking the flying height at a reference level;

FIG. 7 is an enlarged partial side view schematically illustrating the flying head slider taking the flying height at the maximum level;

FIG. 8 is an enlarged partial side view schematically illustrating the flying head slider taking the flying height at the minimum level;

FIG. 9 is an enlarged partial perspective view schematically illustrating a head suspension assembly according to a second embodiment of the present invention;

FIG. 10 is an enlarged partial perspective view, observed in a different direction from the direction of FIG. 9, schematically illustrating the head suspension assembly;

FIG. 11 is an enlarged partial side view schematically illustrating the flying head slider taking the flying height at a reference level;

FIG. 12 is an enlarged partial side view schematically illustrating the flying head slider taking the flying height at the maximum level;

FIG. 13 is an enlarged partial side view schematically illustrating the flying head slider taking the flying height at the minimum level;

FIG. 14 is an enlarged partial perspective view schematically illustrating a head suspension assembly according to a third embodiment of the present invention;

FIG. 15 is an enlarged partial side view schematically illustrating the flying head slider taking the flying height at a reference level;

FIG. 16 is an enlarged partial side view schematically illustrating the flying head slider taking the flying height at the minimum level; and

FIG. 17 is an enlarged partial side view schematically illustrating the flying head slider taking the flying height at the maximum level.

### DESCRIPTION OF THE PREFERRED EMBODIMENTS

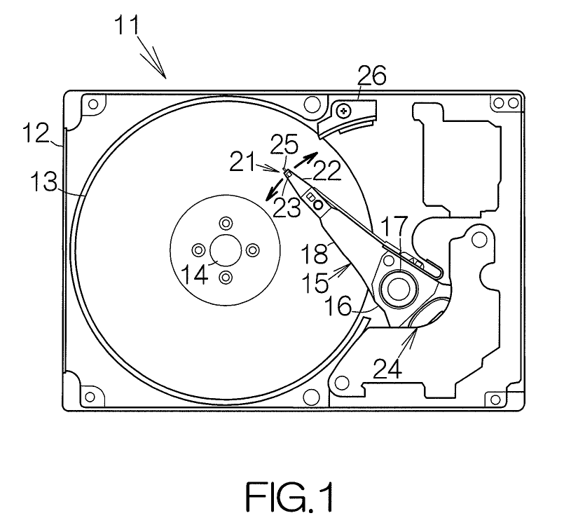

FIG. 1 schematically illustrates the inner structure of a hard disk drive, HDD, 11 as an example of a storage medium drive or storage apparatus. The hard disk drive 11 includes a box-shaped enclosure body 12 defining an inner space of a flat parallelepiped, for example. The enclosure body 12 may be made of a metallic material such as aluminum, for example. Molding process may be employed to form the enclosure body 12. An enclosure cover, not shown, is coupled to the enclosure body 12. The enclosure cover closes the opening of the inner space within the enclosure body 12. Pressing process may be employed to form the enclosure cover out of a plate material, for example.

At least one magnetic recording disk 13 as a storage medium is enclosed in the enclosure body 12. The magnetic recording disk or disks 13 are mounted on the driving shaft of a spindle motor 14. The spindle motor 14 drives the magnetic recording disk or disks 13 at a higher revolution speed such as 5,400 rpm, 7,200 rpm, 10,000 rpm, or the like.

A carriage 15 is also enclosed in the enclosure body 12. The carriage 15 includes a carriage block 16. The carriage block 16 is supported on a vertical support shaft 17 for relative rotation. Carriage arms 18 are defined in the carriage block 16. The carriage arms 18 extend in the horizontal direction from the vertical support shaft 17. The carriage block 16 may be made of aluminum, for example. Molding process may be employed to form the carriage block 16, for example.

A head suspension assembly 21 is attached to the front or tip end of the individual carriage arm 18. The head suspension assembly 21 includes a head suspension 22. The head suspension 22 extends forward from the tip end of the carriage arm 18. A predetermined urging force is applied to the front or tip end of the head suspension 22 toward the surface of the corresponding magnetic recording disk 13. A flying head slider 23 is fixed to the tip end of the head suspension 22.

A medium-opposed surface is defined on the flying head slider 23. The flying head slider 23 opposes the medium-opposed surface to the surface of the magnetic recording disk 13 at a distance. An electromagnetic transducer, not shown, is mounted on the flying head slider 23. The electromagnetic transducer includes a write element and a read element. The write element may include a thin film magnetic head designed to write magnetic bit data onto the magnetic recording disk 13 by utilizing a magnetic field induced at a thin film coil pattern, for example. The read element may include a giant magnetoresistive (GMR) element or a tunnel-junction magnetoresistive (TMR) element designed to discriminate magnetic bit data on the magnetic recording disk 13 by utilizing variation in the electric resistance of a spin valve film or a tunnel-junction film, for example.

When the magnetic recording disk 13 rotates, the flying head slider 23 is allowed to receive airflow generated along the rotating magnetic recording disk 13. The airflow serves to generate a positive pressure or a lift as well as a negative pressure on the flying head slider 23. The lift is balanced with the negative pressure and the urging force from the head suspension 22, so that the flying head slider 23 keeps flying above the surface of the magnetic recording disk 13 during the rotation of the magnetic recording disk 13 at a higher stability. Here, the positive pressure is a pressure higher than atmospheric pressure. The negative pressure is a pressure lower than the atmospheric pressure.

A power source, namely a voice coil motor, VCM, 24 is coupled to the carriage block 16. The voice coil motor 24 serves to drive the carriage block 16 around the vertical support shaft 17. The rotation of the carriage block 16 allows the carriage arms 18 and the head suspensions 22 to swing. When the carriage arm 18 swings around the vertical support shaft 17, the flying head slider 23 is allowed to move along the radial direction of the magnetic recording disk 13. The electromagnetic transducer on the flying head slider 23 can thus be positioned right above a target recording track on the magnetic recording disk 13.

A load tab 25 is defined in the head suspension 22 at the front or tip end of the head suspension 22. The load tab 25 extends forward from the head suspension 22. The load tab 25 is allowed to move in the radial direction of the magnetic recording disk 13 based on the swinging movement of the carriage arm 18. A ramp member 26 is located outside the magnetic recording disk 13 on the movement path of the load tab 25. The tip end of the ramp member 26 is opposed to a non-data zone outside the outermost recording track on the magnetic recording disk 13. The ramp member 26 and the load tabs 25 in combination establish a so-called load/unload mechanism. The ramp member 26 may be made of a hard plastic material, for example.

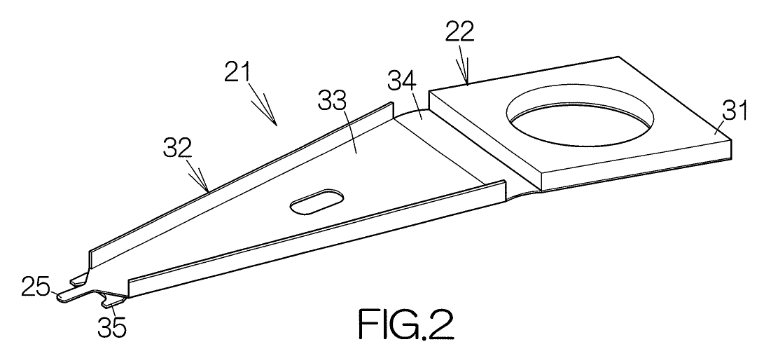

Next, a detailed description will be made on the head suspension assembly 21. As shown in FIG. 2, for example, the head suspension 22 includes an attachment plate 31 and a load beam 32 extending forward from the attachment plate 31. Caulking may be employed to fix the attachment plate 31 to the carriage arm 18, for example. The load beam 32 defines a rigid portion 33 and an elastic bending section 34. The rigid portion 33 is spaced from the attachment plate 31 at a predetermined interval. The elastic bending section 34 is defined between the rigid portion 33 and the attachment plate 31.

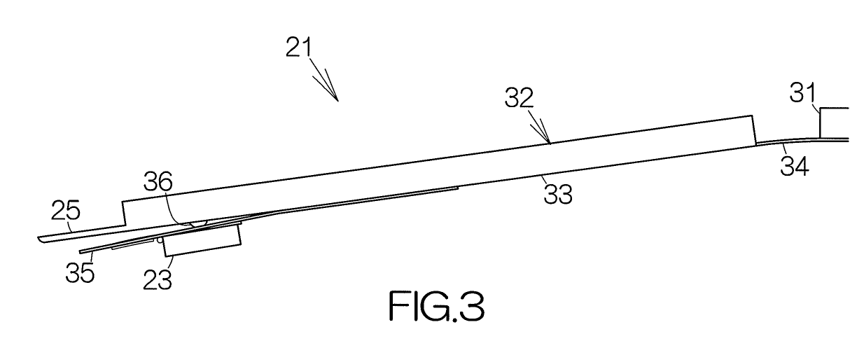

A support body, namely the flexure 35, is attached to the front end of the load beam 32. Referring also to FIG. 3, the flying head slider 23 is mounted on the flexure 35. When the flying head slider 23 is attached to the surface of the load beam 32, the flexure 35 is received on a domed swelling 36 at a position behind the flying head slider 23. The domed swelling 36 is formed on the surface of the rigid portion 33.

The elastic bending section 34 of the load beam 32 is designed to exhibit elasticity or bending force of a predetermined intensity. The bending force serves to provide the aforementioned urging force of the head suspension 22 to the front end of the rigid portion 33. The domed swelling 36 behind the flying head slider 23 serves to apply the urging force to the flying head slider 23. The flying head slider 23 is allowed to enjoy a change in its flying attitude based on the lift generated based on airflow. The domed swelling 36 accepts a change in the attitude of the flying head slider 23.

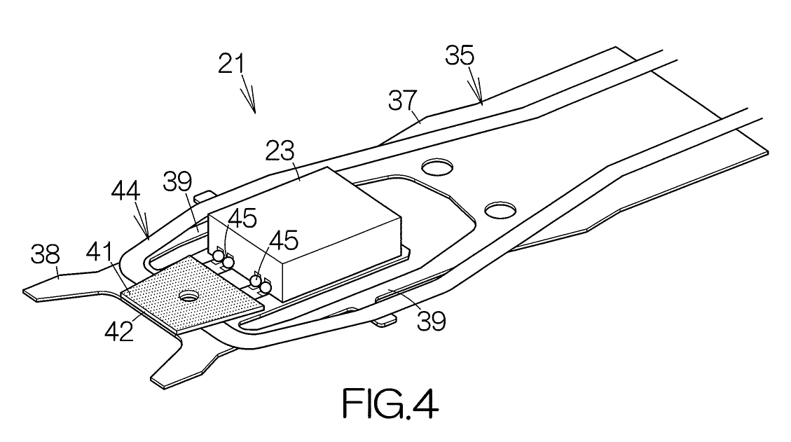

As shown in FIG. 4, the flexure 35 includes a support plate 37 and a fixation plate 38. The support plate 37 is fixed on the surface of the rigid portion 33. The fixation plate 38 receives the flying head slider 23 at a predetermined mounting area defined on the surface of the fixation plate 38. The flying head slider 23 is bonded to the surface of the fixation plate 38, for example, with an adhesive. A pair of gimbal springs 39, 39 connects the support plate 37 to the fixation plate 38. The gimbal springs 39 extend forward from the front end of the support plate 37. The fixation plate 38 extends backward at a position between the gimbal springs 39, 39. The gimbal springs 39 accept a change in the attitude of the fixation plate 38, namely of the flying head slider 23. The support plate 37, the fixation plate 38 and the gimbal springs 39, 39 are made out of a single leaf spring material. The leaf spring material may be a stainless steel plate having a constant thickness, for example.

A piezoelectric element 41 is fixed on the surface of the fixation plate 38 at a predetermined mounting area defined outside the mounting area for the flying head slider 23. The mounting area for the piezoelectric element 41 is defined in the tip end of the fixation plate 38, namely the tip end of the flexure 35. The piezoelectric element 41 includes a pair of film or sheet electrodes and a piezoelectric thin film made of piezoelectric ceramic interposed between the electrodes. Here, one of the electrodes is a metallic thin plate 42. The metallic thin plate 42 may be a stainless steel plate having a constant thickness, for example. Spot welding or bonding is employed to fix the metallic thin plate 42 to the surface of the fixation plate 38. A conventional sputtering technique may be employed to form a piezoelectric thin film on the metallic thin plate 42, for example. The piezoelectric element 41 may be bonded on the metallic thin plate 42 with an adhesive, for example.

One of the electrodes, namely the metallic thin plate 42, extends along the surface of the fixation plate 38 in the piezoelectric element 41. The other electrode extends in parallel with the metallic thin plate 42. A driving voltage is applied to the piezoelectric thin film between the electrodes as described later. The piezoelectric thin film is thus polarized in the direction perpendicular to the widest surface of the piezoelectric thin film, namely in the direction across the thickness. The piezoelectric thin film, namely the piezoelectric element 41, elongates in the direction perpendicular to the widest surface of the piezoelectric thin film in response to a further application of a driving voltage after the polarization. Specifically, the piezoelectric thin film gets thicker. The elongation in the direction perpendicular to the widest surface of the piezoelectric thin film induces shrinkage in the longitudinal direction of the flexure 35. The piezoelectric element 41 and the fixation plate 38 of the mounting area for the piezoelectric element 41 in combination in this manner serve as a so-called unimorph type piezoelectric actuator.

A flexible printed wiring board 44 extends on the surface of the flexure 35. One end of the flexible printed wiring board 44 is connected to the flying head slider 23. The flexible printed wiring board 44 is interposed between the fixation plate 38 and the metallic thin plate 42 at the mounting area for the piezoelectric element 41. The flexible printed wiring board 44 includes a metallic thin plate made of stainless steel. The metallic thin plate receives an insulating layer, an electrically-conductive layer and a protection layer layered in this sequence, for example. The electrically-conductive layer may be made of an electrically-conductive material such as Cu, for example. The insulating layer and the protection layer may be made of a resin material such as polyimide resin, for example.

The electrically-conductive layer includes wiring patterns extending on the flexible printed wiring board 44. The wiring patterns are connected to the flying head slider 23 and the piezoelectric thin film of the piezoelectric element 41. The flying head slider 23 is connected to electrically-conductive pads on the flexible printed wiring board 44 through contact points 45, for example. In this manner, sensing current and writing current are supplied to the flying head slider 23 through the wiring patterns of the flexible printed wiring board 44. Likewise, a predetermined driving voltage is supplied to the piezoelectric thin film of the piezoelectric element 41 through the wiring patterns of the flexible printed wiring board 44.

Next, a detailed description will be made on the structure of the flying head slider 23. As shown in FIG. 5, for example, the flying head slider 23 includes a slider body 51 in the form of a flat parallelepiped. A medium-opposed surface, namely a bottom surface 52, is defined over the slider body 51. The bottom surface 52 is opposed to the magnetic recording disk 13 at a distance. A flat base surface 53 is defined on the bottom surface 52. When the magnetic recording disk 13 rotates, airflow 54 flows along the bottom surface 52 from the inflow or front end toward the outflow or rear end of the slider body 51. The slider body 51 may include a base mass 55 made of Al₂O₃—TiC and an Al₂O₃ (alumina) film 56 overlaid on the outflow or trailing end of the base mass 55, for example.

A front rail 57 is formed on the bottom surface 52 of the slider body 51. The front rail 57 stands upright from the base surface 53 at a position near the upstream or inflow end of the slider body 51. The front rail 57 extends along the inflow end of the base surface 53 in the lateral direction perpendicular to the direction of the airflow 54. A pair of rear side rails 58, 58 also stand upright from the base surface 53 at positions near the downstream or outflow end of the slider body 51. The rear side rails 58 are located near the side edges of the base surface 53, respectively. A rear center rail 59 stands upright from the base surface 53 at a position between the rear side rails 58. The rear center rail 59 extends upstream in the longitudinal direction from the outflow end of the base surface 53 toward the inflow end of the base surface 53.

A pair of side rails 61, 61 are connected to the front rail 57. The side rails 61 stand upright from the base surface 53. The side rails 61, 61 extend downstream along the side edges of the base surface 53 in the longitudinal direction from the front rail 57 toward the rear side rails 58, 58, respectively. Gaps are defined between the side rails 61, 61 and the corresponding rear side rails 58, 58, respectively. The gaps allow airflow to run through between the side rails 61 and the corresponding rear side rails 58, respectively. The side rails 61, 61 may extend in parallel with each other.

So-called air bearing surfaces 62, 63, 64 are defined on the top surfaces of the front rail 57, the rear side rails 58 and the rear center rail 59, respectively. The air bearing surfaces 62, 63, 64 extend within a plane extending in parallel with the base surface 53 at a position distanced from the base surface 53. Steps 65, 66, 67 are formed at the inflow ends of the air bearing surfaces 62, 63, 64. The steps 65, 66, 67 are designed to connect the inflow ends of the air bearing surfaces 62, 63, 64 to the top surfaces of the corresponding rails 57, 58, 59, respectively. Here, the steps 65, 66, 67 may have the same height.

The aforementioned electromagnetic transducer, namely a read/write head element 68, is mounted on the slider body 51. The read/write head element 68 is embedded in the alumina film 56 of the slider body 51. A read gap and a write gap of the read/write head element 68 are exposed at the air bearing surface 64 of the rear center rail 59. A DLC (diamond-like-carbon) protecting film may be formed on the surface of the air bearing surface 64. The DLC protecting film covers over the front end of the read/write head element 68.

The airflow 54 is generated along the surface of the rotating magnetic recording disk 13. The airflow 54 flows along the bottom surface 52 of the slider body 51. The steps 65, 66, 67 serve to generate a relatively large positive pressure or lift on the air bearing surfaces 62, 63, 64, respectively. A negative pressure is generated behind the front rail 57. The negative pressure is balanced with the lift on the flying head slider 23. This balance serves to establish the flying attitude, namely the pitched attitude of the flying head slider 23.

The pitched attitude of the flying head slider 23 takes a pitch angle α. The pitch angle α is angle of inclination in the longitudinal direction of the slider body 51 along the direction of the airflow. The slider body 51 is thus forced to get closest to the magnetic recording disk 13 at the outflow end of the slider body 51. An increase in the pitch angle α results in a reduction in the flying height of the flying head slider 23. It should be noted that the flying head slider 23 can take any shape or form different from the aforementioned one.

Now, assume that the flying height of the flying head slider 23 is controlled during the flight of the flying head slider 23. The urging force of the load beam 32 acts on the flying head slider 23 from the domed swelling 36. A driving voltage of a first value is applied to the piezoelectric thin film. The piezoelectric thin film is polarized in response to the application of the driving voltage of the first value. The piezoelectric thin film expands in the direction of the driving voltage. The piezoelectric thin film thus shrinks in the longitudinal direction of the flexure 35. The flexure 35 is thus forced to deform. The fixation plate 38 bends at the mounting area for the piezoelectric element 41, as shown in FIG. 6. The flying head slider 23 takes a reference flying attitude of a predetermined pitch angle α. The flying height of the flying head slider 23 is set at a predetermined reference level from the surface of the magnetic recording disk 13.

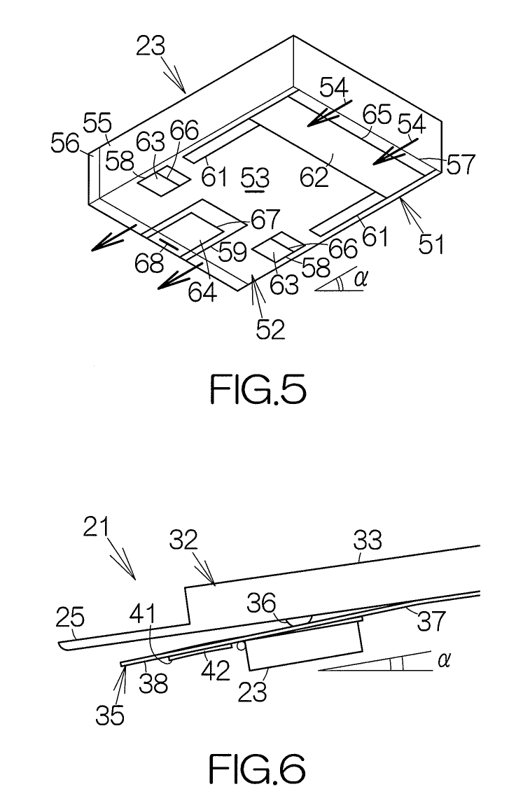

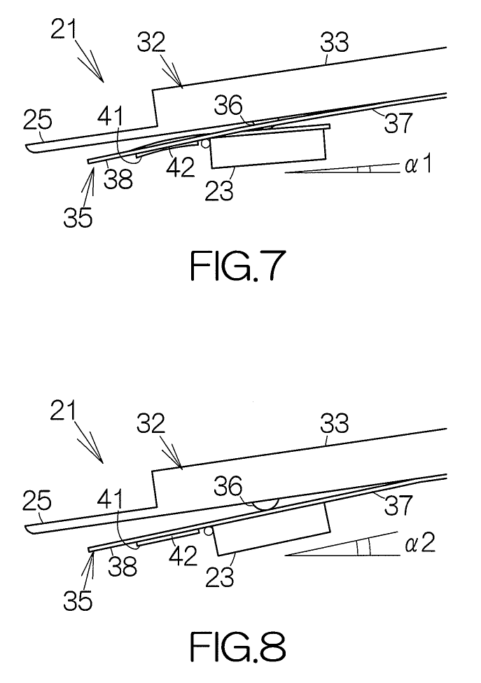

When a driving voltage of a second value larger than the first value is applied to the piezoelectric thin film, the piezoelectric thin film shrinks farthest in the longitudinal direction of the flexure 35. The flexure 35 thus deforms. The fixation plate 38 warps back farthest at the mounting area for the piezoelectric element 41, as shown in FIG. 7. The flying head slider 23 takes a first flying attitude of a pitch angle α1 smaller than the predetermined pitch angle α. In this manner, the piezoelectric actuator forcefully changes the pitched attitude of the flying head slider 23. A reduction in a pitch angle results in an increase in the flying height of the flying head slider 23. The flying height of the flying head slider 23 is thus set at the maximum level larger than the reference level.

When the application of the driving voltage to the piezoelectric thin film is stopped, the piezoelectric thin film expands farthest in the longitudinal direction of the flexure 35. The flexure 35 thus deforms. The warp of the fixation plate 38 is thus eliminated as shown in FIG. 8. The flying head slider 23 takes a second flying attitude of a pitch angle α2 larger than the predetermined pitch angle α. In this manner, the piezoelectric actuator forcefully changes the pitched attitude of the flying head slider 23. An increase in a pitch angle results in a reduction in the flying height of the flying head slider 23. The flying height of the flying head slider 23 is set at the minimum level smaller than the reference level. The pitch angle of the flying head slider 23 in this manner changes within a range between the pitch angle α1 and the pitch angle α2 in response to the shrinkage of the piezoelectric element 41.

The flying head slider 23 flies in a predetermined pitched attitude in the hard disk drive 11. The piezoelectric thin film gets narrowed or shrinks in a plane in response to application of a driving voltage. Shrinkage of the piezoelectric thin film results in deformation of the fixation plate 38. The pitch angle of the flying head slider 23 thus changes. A change in the pitch angle results in a change in the flying height of the flying head slider 23. Accordingly, the control on the voltage level of the driving voltage within a range between the first and second values enables the adjustment of the flying height of the flying head slider 23. The piezoelectric element 41 is simply fixed to a conventional flexure, namely the flexure 35, so as to control the flying height. The piezoelectric element 41 can be fixed to the flexure 35 at a position outside the mounting area for the flying head slider 23 in a facilitated manner. As compared with the case where a piezoelectric element is fixed within the mounting area for the flying head slider 23, for example, it is possible to avoid an additional processing on the flying head slider 23, an increase in the thickness of the flying head slider 23, and the like. Any design change may not be required for the flying head slider 23. A conventional flying head slider can be employed as the flying head slider 23. The flying height can thus be controlled at a low cost.

FIG. 9 schematically illustrates a head suspension assembly 21a according to a second embodiment of the present invention. The head suspension assembly 21a includes a flexure 35a. The flying head slider 23 is partly received on one end of the fixation plate 38. The piezoelectric element 41 is fixed on the surface of the fixation plate 38 at a predetermined mounting area outside the mounting area for the flying head slider 23 in the same manner as described above.

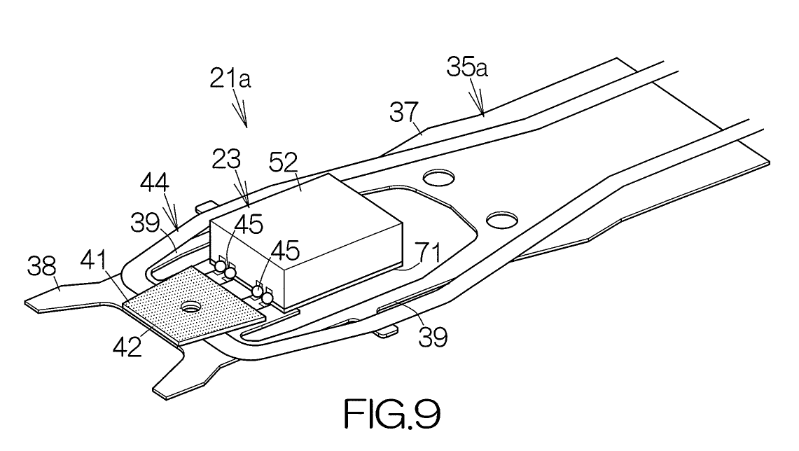

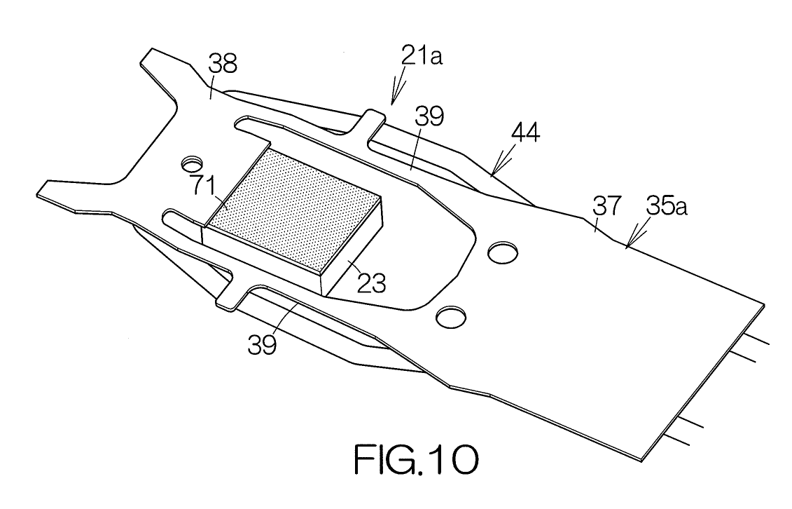

Referring also to FIG. 10, a piezoelectric element 71 is fixed to the back surface of the flying head slider 23, opposite to the front surface defining the bottom surface 52. The piezoelectric element 71 includes a pair of film or sheet electrodes and a piezoelectric thin film made of piezoelectric ceramic interposed between the electrodes. The piezoelectric element 71 may be connected to the aforementioned piezoelectric element 41 through the wiring patterns on the flexible printed wiring board 44. A driving voltage is supplied to the piezoelectric element 71 through the wiring patterns. Here, the piezoelectric element 41 is allowed to shrink in the longitudinal direction of the flying head slider 23 in response to application of the driving voltage. The piezoelectric element 71 and the flying head slider 23 in combination serve as a so-called unimorph type piezoelectric actuator.

Here, the bottom surface 52 of the flying head slider 23 is an inflated curved surface. The curved surface has generatrices extending in the lateral direction of the flying head slider 23 in parallel with the inflow and outflow ends of the slider body 51. The curved surface has a predetermined curvature. The curvature of the curved surface serves to determine the pitched attitude of the flying head slider 23. An increase in the curvature of the curved surface results in an increase in the flying height of the flying head slider 23. Like reference numerals are attached to the structure or components equivalent to those of the aforementioned first embodiment.

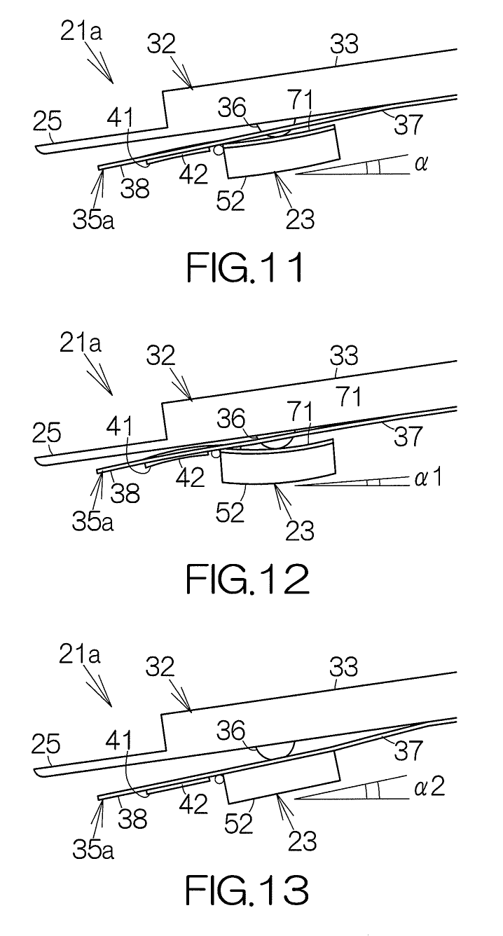

Now, assume that the flying height of the flying head slider 23 is controlled during the flight of the flying head slider 23. The urging force of the load beam 32 acts on the flying head slider 23 from the domed swelling 36. A driving voltage of a first value is applied to the piezoelectric thin film. The piezoelectric thin film of the piezoelectric element 41 shrinks in the longitudinal direction of the flexure 35a. The fixation plate 38 thus warps back at the mounting area for the piezoelectric element 41, as shown in FIG. 11. The flying head slider 23 takes a reference flying attitude of a predetermined pitch angle α. Simultaneously, the piezoelectric thin film of the piezoelectric element 71 shrinks in the longitudinal direction of the flying head slider 23. The flying head slider 23 thus warps back. The curvature of the bottom surface 52 increases. The flying height of the flying head slider 23 is set at a predetermined reference level from the surface of the magnetic recording disk 13.

When a driving voltage of a second value larger than the first value is applied to the piezoelectric thin film of the piezoelectric element 41, the piezoelectric thin film shrinks farthest in the longitudinal direction of the flexure 35a. The fixation plate 38 thus warps back farthest at the mounting area for the piezoelectric element 41, as shown in FIG. 12. The flexure 35a correspondingly deforms. The flying head slider 23 takes a first flying attitude of a pitch angle α1 smaller than the predetermined pitch angle α. Simultaneously, the piezoelectric thin film of the piezoelectric element 71 shrinks in the longitudinal direction of the flying head slider 23. The flying head slider 23 thus warps back farthest. The curvature of the bottom surface 52 is maximized. The flying height of the flying head slider 23 in this manner increases. The flying height of the flying head slider 23 is set at the maximum level larger than the reference level.

When the application of the driving voltage to the piezoelectric thin film of the piezoelectric element 41 is stopped, the piezoelectric thin film expands farthest in the longitudinal direction of the flexure 35a. The flexure 35a thus deforms. The flying head slider 23 thus takes a second flying attitude of a pitch angle α2 larger than the predetermined pitch angle α, as shown in FIG. 13. Simultaneously, the piezoelectric thin film of the piezoelectric element 71 expends farthest in the longitudinal direction of the flying head slider 23. The curvature of the bottom surface 52 is reduced. The flying height of the flying head slider 23 is thus reduced. The flying height of the flying head slider 23 is set at the minimum level smaller than the reference level.

The shrinkage of the piezoelectric thin film of the piezoelectric element 41 serves to change the pitch angle of the flying head slider 23. A change in the pitch angle results in a change in the flying height of the flying head slider 23. Moreover, the shrinkage of the piezoelectric thin film of the piezoelectric element 71 serves to change the curvature of the bottom surface 52. A change in the curvature serves to induce a change in the flying height of the flying head slider 23. Although the piezoelectric element 71 is additionally fixed to the flying head slider 23 for controlling the flying height, the flying head slider 23 is allowed to enjoy an enhanced change in the flying height based on a change in the curvature of the bottom surface 52. It should be noted that the piezoelectric elements 41, 71 may be formed integral with each other.

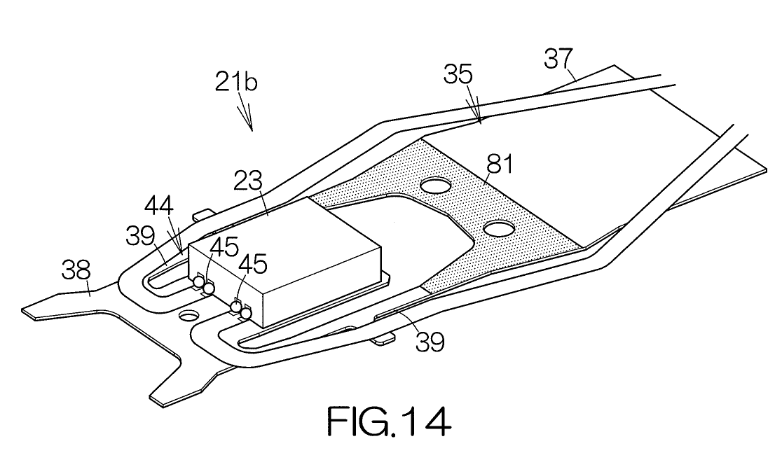

FIG. 14 schematically illustrates a head suspension assembly 21b according to a third embodiment of the present invention. The head suspension assembly 21b includes a piezoelectric element 81. The piezoelectric element 81 is fixed on the surface of the flexure 35 at a predetermined mounting area outside the mounting area for the flying head slider 23. Here, the piezoelectric element 81 extends over the support plate 37 and the gimbal springs 39. The piezoelectric element 81 includes a pair of film or sheet electrodes and a piezoelectric thin film made of piezoelectric ceramic interposed between the electrodes. The wiring patterns on the flexible printed wiring board 44 are connected to the piezoelectric thin film. A driving voltage is applied through the wiring patterns.

One of the electrodes extends along the surface of the flexure 35 in the piezoelectric element 81. The other electrode extends in parallel with the one electrode. The piezoelectric thin film is polarized in the direction perpendicular to the widest surface of the piezoelectric thin film in response to application of a driving voltage in the same manner as described above. The piezoelectric thin film, namely the piezoelectric element 81, shrinks in a plane along the surface of the flexure 35, namely in the longitudinal direction of the flexure 35. The piezoelectric element 81 and the flexure 35 of the mounting area in combination in this manner serve as a so-called unimorph type piezoelectric actuator. Like reference numerals are attached to the structure or components equivalent to those of the aforementioned first and second embodiments.

Now, assume that the flying height of the flying head slider 23 is controlled during the flight of the flying head slider 23. The urging force of the load beam 32 acts on the flying head slider 23 from the domed swelling 36. A driving voltage of a first value is applied to the piezoelectric thin film. The piezoelectric thin film shrinks in the longitudinal direction of the flexure 35. The support plate 37 and the gimbal springs 39 thus warp back at the mounting area for the piezoelectric element 81. The tip end of the flexure 35 is thus distanced from the surface of the load beam 32, as shown in FIG. 15. The flying head slider 23 in this manner takes a reference flying attitude of a predetermined pitch angle α. The flying height of the flying head slider 23 is set at a predetermined reference level from the surface of the magnetic recording disk 13.

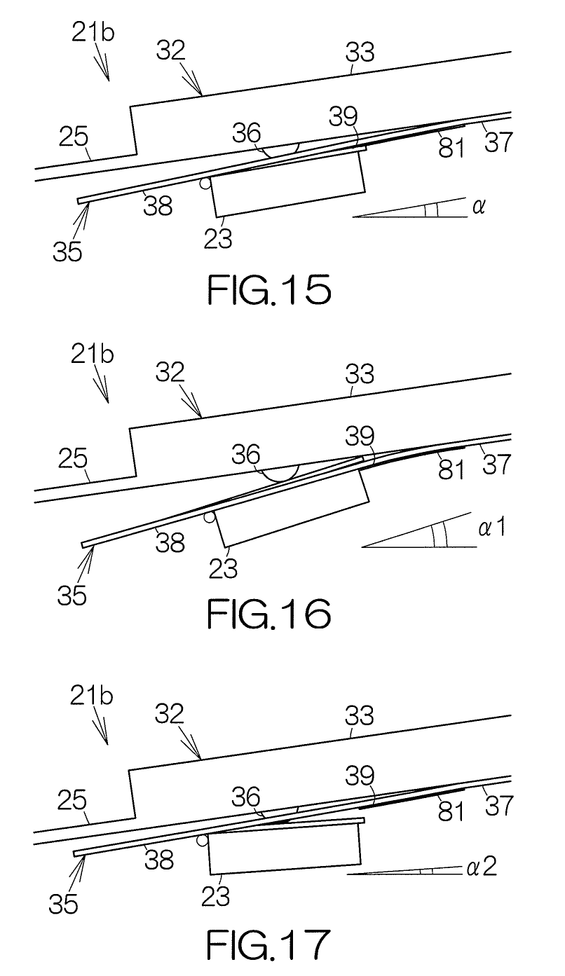

When a driving voltage of a second value larger than the first value is applied, the piezoelectric thin film shrinks farthest in the longitudinal direction of the flexure 35. The support plate 37 and the gimbal springs 39 thus warps back farthest at the mounting area for the piezoelectric element 81. The tip end of the flexure 35 moves farthest from the surface of the load beam 32. The flying head slider 23 takes a first flying attitude of a pitch angle α1 larger than the predetermined pitch angle α, as shown in FIG. 16. The flying height of the flying head slider 23 is reduced. The flying height of the flying head slider 23 is set at the minimum level smaller than the reference level.

When the application of the driving voltage to the piezoelectric thin film is stopped, the piezoelectric thin film expands farthest in the longitudinal direction of the flexure 35. The tip end of the flexure 35 moves to a position closest to the surface of the load beam 32. Since the flying head slider 23 is received on the domed swelling 36 behind the fixation plate 38, the flying head slider 23 takes a second flying attitude of a pitch angle α2 smaller than the predetermined pitch angle α, as shown in FIG. 17. The flying height of the flying head slider 23 correspondingly increases. The flying height of the flying head slider 23 is set at the maximum level larger than the reference level.

When the piezoelectric thin film shrinks in the hard disk drive 11, the support plate 37 and the gimbal springs 39 deform. The pitch angle of the flying head slider 23 thus changes. A change in the pitch angle results in a change in the flying height of the flying head slider 23. Accordingly, the control on the voltage level of the driving voltage enables adjustment of the flying height of the flying head slider 23. The flying height can be controlled without changing the design of the flying head slider 23. A conventional flying head slider can be employed as the flying head slider 23. The flying height can thus be controlled at a low cost.

The hard disk drive 11 may accept the control on the pitch angle and/or the curvature of the flying head slider 23 during the movement of the load tab 25 along the ramp member 26.

What is claimed is:

1. A storage apparatus comprising:
a head slider having a medium-opposed surface opposed to a storage medium at a distance, the head slider designed to move relative to the storage medium;
a suspension exhibiting an urging force directed toward the storage medium;
a flexure fixed to the suspension, the flexure holding the head slider at a predetermined mounting area; and
an actuator causing deformation of the flexure outside the predetermined mounting area so as to change a flying attitude of the head slider within a predetermined range of a pitch angle.

2. The storage apparatus according to claim 1, further comprising a piezoelectric element fixed to a surface of the flexure at a position outside the predetermined mounting area, the piezoelectric element establishing the actuator.

3. The storage apparatus according to claim 2, wherein the piezoelectric element includes a thin film made of piezoelectric ceramic.

4. The storage apparatus according to claim 2, wherein the actuator is a unimorph type piezoelectric actuator.

5. The storage apparatus according to claim 2, further comprising a piezoelectric element fixed to a back surface of the head slider, the head slider having a front surface including the medium-opposed surface.

6. A head suspension assembly comprising:
a head slider having a medium-opposed surface opposed to a storage medium at a distance, the head slider designed to move relative to the storage medium;
a suspension exhibiting an urging force directed toward the storage medium;
a flexure fixed to the suspension, the flexure holding the head slider at a predetermined mounting area; and
an actuator causing deformation of the flexure outside the predetermined mounting area so as to change a flying attitude of the head slider within a predetermined range of a pitch angle.

7. The head suspension assembly according to claim 6, further comprising a piezoelectric element fixed to a surface of the flexure at a position outside the predetermined mounting area, the piezoelectric element establishing the actuator.

8. The head suspension assembly according to claim 7, wherein the piezoelectric element includes a thin film made of piezoelectric ceramic.

9. The head suspension assembly according to claim 7, wherein the actuator is a unimorph type piezoelectric actuator.

10. The head suspension assembly according to claim 7, further comprising a piezoelectric element fixed to a back surface of the head slider, the head slider having a front surface including the medium-opposed surface.

11. A head suspension assembly comprising:
a head slider;
a suspension;
a flexure fixed to the suspension, the flexure receiving the head slider at a predetermined mounting area, the flexure enabling a change in an attitude of the head slider; and
a piezoelectric element fixed to a surface of the flexure at a position outside the predetermined mounting area.

12. The head suspension assembly according to claim 11, further comprising a piezoelectric element fixed to a back surface of the head slider, the head slider having a front surface including a medium-opposed surface.
